(19) United States
(12) Patent Application Publication
(10) Pub. No.: US 2014/0230245 A1
(43) Pub. Date: Aug. 21, 2014

(54) METHOD FOR REPAIRING SURFACE DAMAGE TO A TURBOMACHINE COMPONENT

(71) Applicant: Siemens Aktiengesellschaft, Munich (DE)

(72) Inventors: Jochen Barnikel, Mulheim an der Ruhr (DE); Susanne Gollerthan, Bochum (DE); Harald Krappitz, Kirchheim unter Teck (DE); Ingo Reinkensmeier, Frondenberg (DE)

(73) Assignee: SIEMENS AKTIENGESELLSCHAFT, Munich (DE)

(21) Appl. No.: 14/350,865

(22) PCT Filed: Sep. 21, 2012
(86) PCT No.: PCT/EP2012/068652

§ 371 Date: Apr. 10, 2014

(30) Foreign Application Priority Data
Oct. 14, 2011 (EP) 11185208.3

(51) Int. Cl. B23P 6/00

(52) U.S. Cl. CPC B23P 6/007
USPC 29/889.1

(57) ABSTRACT

A method for repairing surface damage to a turbomachine component that has a base material which has titanium with the base material having TiAl6V4 and/or pure titanium is provided. The method includes the following steps: mixing a solder that has a titanium-containing alloy and a powder which is distributed in the solder and which has the base material; applying the solder onto turbomachine component areas where the surface damage is located; introducing a quantity of heat into the solder and into the turbomachine component such that the alloy liquefies and the areas are thus wetted; and cooling the solder such that the alloy solidifies.

### CROSS REFERENCE TO RELATED APPLICATIONS

This application is the U.S. National Stage of International Application No. PCT/EP2012/068652 filed Sep. 21, 2012, and claims the benefit thereof. The International Application claims the benefit of European Application No. EP 11185208 filed Oct. 14, 2011. All of the applications are incorporated by reference herein in their entirety.

### FIELD OF INVENTION

The invention relates to a method for repairing surface damage to a turbomachine component.

### BACKGROUND OF INVENTION

A gas turbine has a compressor and a turbine. Blades or vanes are used both in the compressor and in the turbine, with a distinction being made between stationary guide vanes and rotating rotor blades.

Titanium alloys, which have a high strength, a low density and also good corrosion resistance, are used inter alia as the material for the rotor blades. The titanium alloys disadvantageously have a high notch sensitivity and high cracking sensitivity.

The rotor blades in particular are exposed to various wear processes, e.g. wear by friction or by oxidation. Specifically in a steam turbine, drop impingement erosion occurs as a wear process. Droplets of mist form from water in the steam turbine and are captured by the guide vanes, where they accumulate and break off from the outlet edges of the guide vanes as water drops. The water drops have a low absolute velocity, but, on account of the rotation of the rotor blades, they have a high velocity relative to the rotor blades. If the water drops impinge on the rotor blades with their high relative velocity, this leads to the formation of notches on the surface of the rotor blades.

Various methods are available for reducing the drop impingement erosion. A layer which is resistant to drop impingement erosion can be applied to the surface of the rotor blade by thermal spraying. Furthermore, a hard layer can be applied to the surface of the rotor blade by welding. However, the cracking sensitivity of the rotor blades is disadvantageously increased by said methods, particularly at the interfaces between the titanium alloy and the hard layer, as a result of which the service life of the rotor blades is reduced. Furthermore, it is disadvantageous that the layers cannot be reapplied to the rotor blade after damage caused by drop impingement erosion, because said methods require a smooth surface.

### SUMMARY OF INVENTION

It is an object of the invention to provide a method for repairing surface damage to a turbomachine component and also a turbomachine component which is repaired by the method, in which case the method can be employed easily and repeatedly and also the turbomachine component has a long service life.

The method according to the invention for repairing surface damage to a turbomachine component having a titanium-comprising base material comprises the following steps: mixing a solder comprising a titanium-comprising alloy and a powder which is distributed in the solder and comprises the base material; applying the solder to points of the turbomachine component at which the surface damage is located; introducing a quantity of heat into the solder and into the turbomachine component, such that the alloy becomes liquid and as a result the points are wetted; cooling the solder, such that the alloy becomes solid.

Since both the alloy and the base material comprise titanium and a powder comprising the base material is admixed to the alloy, the solder is similar to the base material in terms of its physical properties, and therefore no sharp metallurgical notches form and the solder advantageously readily bonds to the base material. Particularly in the case of rotor blades, cracks can form at the interface between the base material and the solder during operation of the turbomachine as a result of centrifugal forces or as a result of vibrations. The formation of the cracks is reduced by the good bond between the solder and the base material and by the avoidance of the sharp metallurgical notches, as a result of which a long service life of the turbomachine component is advantageously achieved.

The method according to the invention makes it possible to repair a large number of instances of surface damage, e.g. cracks or instances of surface erosion. Since the alloy becomes liquid, it can advantageously penetrate into cracks, notches, troughs and craters, and fill these. A prerequisite for the repair of cracks is that the cracks are free of oxides. Any desired further geometries of instances of surface erosion are also conceivable in addition to the geometries listed. The method can advantageously be employed easily and for any desired geometries of turbomachine components. It is advantageously possible for the original surface contour of the turbomachine component to be restored after erosion, even when various depths of erosion are present. Furthermore, the method can advantageously be employed repeatedly. If the turbomachine component comprises a previous solder, this is melted in the method and combines with the newly applied solder.

It is preferable that the solder is mixed in such a way that the mass ratio of the alloy to the powder is at least 3:7 and at most 7:3. The base material preferably comprises a titanium alloy, in particular TiAl6V4, pure titanium and/or pure titanium with additives, in particular carbon as an additive. It is preferable that the solder is produced in such a way that it is a paste, a presintered material (presintered preforms, PSP) or a strip, in particular an adhesive strip. As a result, the solder can advantageously be locally applied to the points of the turbomachine component affected by the erosion in a targeted manner.

The composition of the alloy is preferably selected such that the melting temperature of the alloy is lower than the beta transus temperature of the base material. The beta transus temperature of pure titanium is approximately 880° C., and that of TiAl6V4 is approximately 960° C. to 985° C. Below this temperature, the lattice structure of the titanium is a very close-packed hexagonal structure, and above this temperature a body-centered cubic lattice structure forms. A change in the lattice structure disadvantageously shortens the service life of the turbomachine component. Since the melting temperature of the alloy lies below the beta transus temperature, the change in the lattice structure of the base material is avoided, as a result of which the service life of the turbomachine component is advantageously long.

The alloy is preferably a brazing solder, in particular with a melting temperature of between 750° C. and 950° C. The brazing solder is advantageously resistant to drop impingement erosion.

It is preferable that the solder comprises nonmetallic, semi-metallic and/or ceramic particles, the constituents of which are bound in the liquid alloy by diffusion processes and form a hard material in a chemical reaction with the alloy. The particles preferably comprise carbon-containing compounds, in particular graphite, and the hard material titanium carbide is formed from the carbon and the alloy. If drop impingement erosion occurs, the alloy can be destroyed, as a result of which the powder is disadvantageously exposed. Since the alloy is hard, it is resistant to drop impingement erosion. The formation of the hard material in the chemical reaction advantageously makes the alloy harder, as a result of which the service life of the turbomachine component is advantageously long. In particular, the titanium carbide formed by the reaction of graphite has an advantageously high strength. Since the particles at least partially dissolve, they change through diffusion processes, and zones made up of the hard material which are larger than the particles form.

The particles are preferably platelet-like and/or spherical. The quantity of heat and the time of introduction thereof are preferably determined in such a manner that the particles are converted in the chemical reaction. The quantity of heat and time of introduction which are required for converting the particles depend on the size of the particles and also on the mass ratio of the alloy and the particles.

The quantity of heat and the time of introduction thereof are preferably determined in such a manner that the dissolved particles partially pass through diffusion into the base material, where they undergo a chemical reaction with the base material, forming a hard material. In the process, the alloy also partially passes into the base material. Similarly thereto, material passes through diffusion from the base material into the alloy. Through the diffusion, and since the hard material is also formed in the base material, there are no longer any erratic differences in the properties, for example the modulus of elasticity or the hardness, between the base material, the hard material and the alloy, as a result of which advantageously sharp metallurgical notches are avoided and the formation of cracks between the base material and the alloy is prevented.

The quantity of heat and the time of introduction thereof are preferably determined in such a way that the temperatures of the solder and of the turbomachine component are lower than the beta transus temperature of the base material. As a result, it is advantageously possible to avoid a change in the lattice structure of the base material.

The turbomachine component according to the invention has a repair layer, which is produced by the method according to the invention.

### BRIEF DESCRIPTION OF THE DRAWINGS

Hereinbelow, the method according to the invention for repairing surface damage to a turbomachine component will be explained on the basis of the attached schematic drawings, in which:

FIG. 1 shows a section of a surface region of a new turbomachine component with impinging drops,

FIG. 2 shows a section of the surface region after drop impingement erosion, and

FIG. 3 shows a section of the surface region after repair by the method according to the invention.

### DETAILED DESCRIPTION OF INVENTION

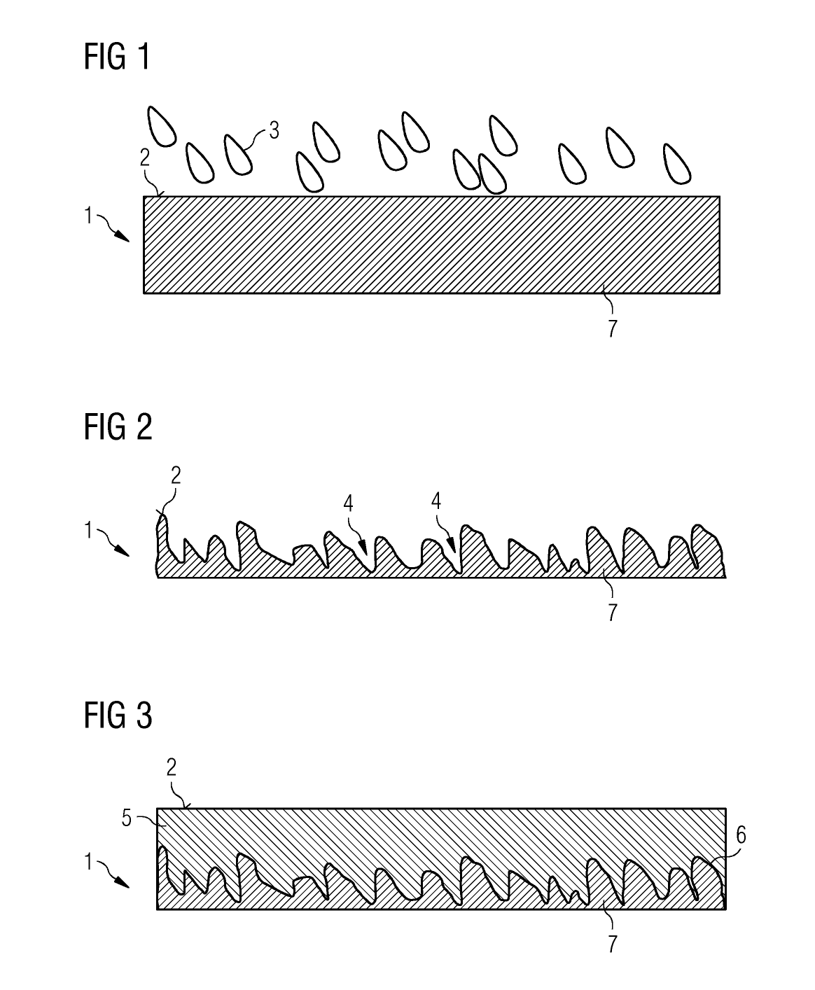

A turbomachine component, e.g. a rotor blade of a steam turbine, has a surface region 1. As can be seen from FIG. 1, the surface region 1 has a base material 7 and also a surface 2 lying at the top. Before the start of the drop impingement erosion, the surface 2 is smooth. A plurality of generally uniform drops 3 are shown, the drops 3 having a wide and convex shape at their front side and tapering toward their rear side. The direction of flight and therefore the angle of impingement of the drops 3 on the surface 2 depends on the geometry of the rotor blades, and can be acute, as shown by way of example in FIG. 1. As soon as the drops impinge on the surface 2, drop impingement erosion forms on the surface 2.

As is shown in FIG. 2, the surface 2 of the surface region 1 is jagged after the drop impingement erosion, and the surface region 1 has a plurality of notches 4. The notches 4 are oriented substantially in the direction of flight of the drops 3 shown in FIG. 1, and the notches 4 have different depths. Any desired eroded shapes, e.g. troughs or cracks, are conceivable, however. On account of the material removal caused by the drop impingement erosion, the turbomachine component is narrower than in FIG. 1.

As can be seen from FIG. 3, a repair layer 5 made of a solder is applied to the eroded surface region 1 shown in FIG. 2. It is conceivable that the solder has been applied to the eroded surface region 1 in the form of an adhesive strip. Since the solder becomes molten through the introduction of heat, it has completely filled the notches 4, and the repair layer 5 is finished after cooling and solidification. The solder and therefore the repair layer 5 in this case comprise an alloy and a powder (not shown) which comprises the base material. An interface 6 is formed between the base material 7 and the repair layer 5. Owing to the good bond between the repair layer 5 and the base material 7, the interface is resistant to the formation of cracks. The original surface contour of the turbomachine component is restored by the method, it being possible in principle to restore surfaces 2 of any desired shape of the turbomachine component.

It is conceivable that a diffusion layer forms at the interface 6, in that material passes through diffusion from the repair layer 5 into the base material 7, or in that material passes from the base material 7 into the repair layer 5. Furthermore, it is conceivable that, in addition to the powder comprising the base material, particles of graphite are distributed in the solder, these dissolving in the alloy of the solder during the supply of heat and forming the hard material titanium carbide in a chemical reaction with the alloy.

Although the invention has been explained and described in more detail by the preferred exemplary embodiment, the invention is not limited by the disclosed examples, and other variations can be derived therefrom by a person skilled in the art without departing from the scope of protection of the invention.

1. A method for repairing surface damage to a turbomachine component having a titanium-comprising base material, wherein the base material comprises TiAl6V4 and/or pure titanium, the method comprising:
mixing a solder comprising a titanium-comprising alloy and a powder which is distributed in the solder and comprises the base material, wherein a composition of the alloy is selected such that a melting temperature of the alloy is lower than a beta transus temperature of the base material, and the solder is mixed in such a way that a mass ratio of the alloy to the powder is at least 3:7 and at most 7:3;
applying the solder to points of the turbomachine component at which the surface damage is located;
introducing a quantity of heat into the solder and into the turbomachine component, such that the alloy becomes liquid and as a result the points are wetted;
cooling the solder, such that the alloy becomes solid.

2. The method as claimed in claim 1,
wherein the solder is produced in such a way that it is a paste, a presintered material or a strip.

3. The method as claimed in claim 1,
wherein the alloy is a brazing solder.

4. The method as claimed in claim 1,
wherein the solder comprises nonmetallic, semi-metallic and/or ceramic particles, constituents of which are bound in a liquid alloy by diffusion processes and form a hard material in a chemical reaction with the alloy.

5. The method as claimed in claim 4,
wherein the particles comprise carbon-containing compounds.

6. The method as claimed in claim 4,
wherein the particles are platelet-like and/or spherical.

7. The method as claimed in claim 4,
wherein the quantity of heat and the time of introduction thereof are determined in such a manner that the particles are converted in the chemical reaction.

8. The method as claimed in claim 4,
wherein the quantity of heat and the time of introduction thereof are determined in such a manner that dissolved particles partially pass through diffusion into the base material, where they undergo a chemical reaction with the base material, forming a hard material.

9. The method as claimed in claim 4,
wherein the quantity of heat and the time of introduction thereof are determined in such a way that the temperatures of the solder and of the turbomachine component are lower than the beta transus temperature of the base material.

10. A turbomachine component having a repair layer, wherein the repair layer is produced by a method as claimed in claim 1.

11. The method as claimed in claim 2, wherein the solder is produced in such a way that it is an adhesive strip.

12. The method as claimed in claim 1, wherein the alloy is a brazing solder with a melting temperature of between 750° C. and 950° C.

13. The method as claimed in claim 5, wherein the particles comprise graphite.

14. The method as claimed in claim 5, wherein the hard material titanium carbide is formed from the carbon and the alloy.
